(19) United States
(12) Patent Application Publication
(10) Pub. No.: US 2016/0113397 A1
(43) Pub. Date: Apr. 28, 2016

(54) METHOD FOR PRODUCING A FURNITURE PART, AND FURNITURE PART AND PIECE OF FURNITURE

(71) Applicant: Grass GmbH, Hoechst (AT)

(72) Inventors: Milan KOKANOVIC, Hoechst (AT); Dario IVOS, Dornbirn (AT)

(21) Appl. No.: 14/882,592

(22) Filed: Oct. 14, 2015

(30) Foreign Application Priority Data
Oct. 23, 2014 (DE) 10 2014 115 439.8

(51) Int. Cl. A47B 88/00; B05D 7/00; B05D 5/00

(52) U.S. Cl. CPC A47B 88/00; B05D 5/00; B05D 7/54

(57) ABSTRACT

A method for producing a furniture part, in particular, an element of a drawer, wherein the at least one drawer element is produced from metal or plastic. According to the invention, a nanoceramic layer is applied to a surface of the furniture part before the furniture part is coated with a layer of paint. Moreover, a furniture part is proposed which has a nanoceramic layer applied to its surface.

This application claims the benefit under 35 USC §119(a)-(d) of German Application No. 10 2014 115 439.8 filed Oct. 23, 2014, the entirety of which is incorporated herein by reference.

### FIELD OF THE INVENTION

The present invention relates to a method for producing a furniture part and to a furniture part and to a piece of furniture having such a furniture part.

### BACKGROUND OF THE INVENTION

It is known practice to powder coat hollow-chamber frames of sheet metal for drawers to achieve a desired surface. Such coating is comparatively complicated and cost-intensive.

### SUMMARY OF THE INVENTION

The object on which the present invention is based is to optimize the production of furniture surfaces.

The invention proceeds from a method for producing a furniture part, in particular an element of a drawer, wherein the at least one drawer element is produced from metal or plastic.

The essence of the invention now consists in the fact that a nanoceramic layer is applied to a surface of the furniture part before the furniture part is coated with a layer of paint. The nanoceramic layer has for example a layer thickness in the range from 10 to 500 nm.

The layer thickness is preferably 25 to 100 nm, for example approximately 50 nm. The nanoceramic layer serves to improve the adhesion of the subsequently applied paint, and the corrosion resistance of the furniture part which is coated with this layer system is increased. There is thus the possibility of being able to reduce the thickness of a layer of paint while maintaining the same corrosion resistance, which constitutes a cost saving.

In a particularly preferred embodiment of the invention, the furniture part is coated with a layer of zirconium oxide.

The coating parameters are preferably established in such a way that a layer of zirconium oxide is produced during the coating operation. This layer then preferably lies directly on the base material of the furniture part, in particular, a metal surface. For example, a hollow-chamber frame, which is bent from sheet metal, for a drawer is provided with a zirconium oxide layer.

Moreover, it is preferred if the furniture part is surface treated, in particular cleaned or tempered, before coating with the nanoceramic layer.

To ensure that the nanoceramic layer is deposited homogeneously, the surface of the furniture part is in particular degreased, for example using a customary degreasing process.

In order to avoid the presence of undesired substances on the surface to be coated, it is moreover proposed that at least one rinsing step is carried out after the cleaning operation.

The rinsing step serves to prepare the surface of the nanoceramic layer for coating with subsequent processes.

In a moreover preferred embodiment of the invention, the nanoceramic layer is sprayed onto the surface of the furniture part. This constitutes a comparatively cost-effective possibility of depositing a nanoceramic layer.

Moreover, it is also conceivable to apply the nanoceramic layer to the surface of the furniture part in a bath.

The bath has the advantage that any surface, including concealed areas of the furniture part to be coated, in particular a frame of a piece of furniture, for example a hollow-chamber frame of metal, is reached by the nanoceramic coating as a result of immersion in the bath.

In the case of a furniture part, the essence of the invention consists in the fact that a nanoceramic layer is applied to a surface of the furniture part. The nanoceramic layer preferably has a thickness of 10 to 500 nm, in particular 25 to 100 nm.

Furthermore, it is preferred if a layer of paint is applied to the nanoceramic layer. The layer of paint can be produced for example in a powder coating process.

Insofar as a coating of paint is applied, the layer thickness of the paint is preferably 30 to 100 μm. In such a layer system, it is moreover advantageous if the layer thickness of the nanoceramic layer is 25 to 75 nm.

Such a layer system affords optimized protection of the surface of the furniture part, in particular from corrosion.

It is also conceivable to coat a furniture part made of plastic with a nanoceramic layer before applying a further coat, in particular a layer of paint, for example in a powder coating process.

### BRIEF DESCRIPTION OF THE DRAWINGS

A number of exemplary embodiments of the invention are explained in more detail below while giving further advantages and particulars.

FIG. 1 is a perspective view showing a hollow-chamber frame with a nanoceramic coating; and

FIG. 2 is a schematic basic diagram showing a detail of an installation for applying a nanoceramic layer.

### DETAILED DESCRIPTION OF THE INVENTION

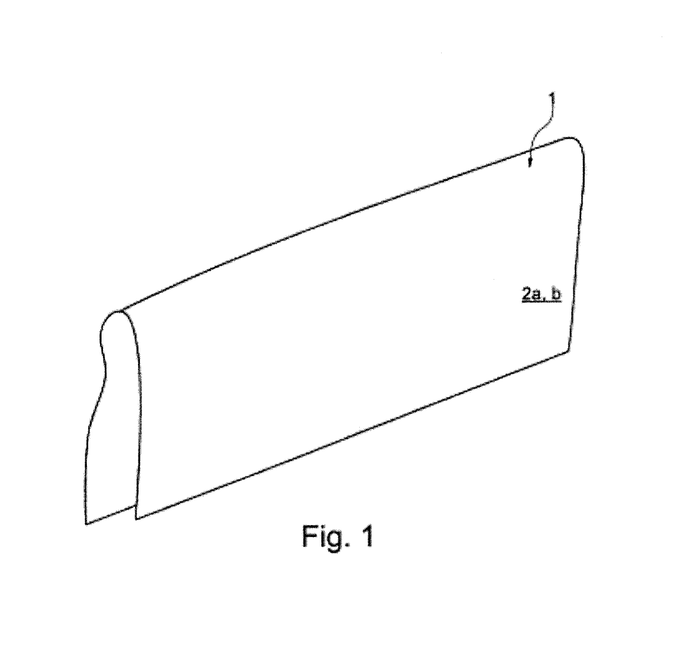

FIG. 1 illustrates a wall element 1 for a hollow-chamber frame of a drawer. The wall element 1 consists, for example, of a bent sheet metal element. The wall element 1 is preferably coated with a layer of paint 2b. Prior to coating, a nanoceramic layer 2a, for example, of zirconium oxide, has been applied to the cleaned surface of the wall element 1.

The nanoceramic layer makes it possible to achieve not only improved adhesion of the paint but also improved covering of the surface of the wall element 1.

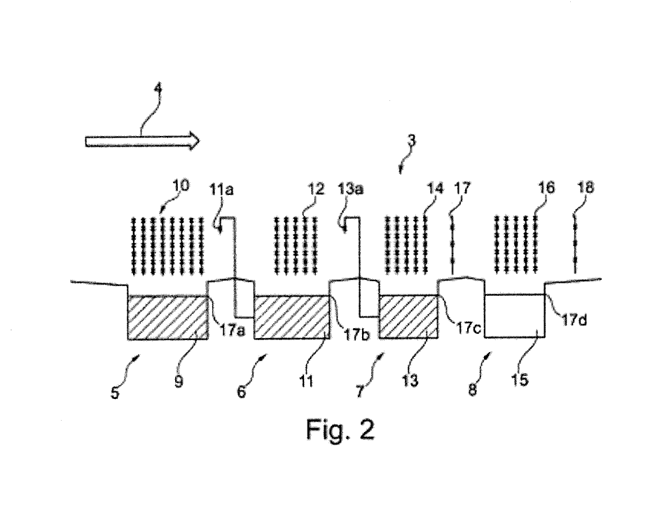

FIG. 2 illustrates a design of an installation 3 for applying a nanoceramic layer.

An arrow 4 is used to illustrate the direction in which, for example, a wall element 1 runs through the installation 3.

The installation 3 has four zones 5 to 8.

First of all, a spray treatment of the furniture part is carried out over a bath 9 by means of spray nozzles 10 using, for example, conventional water. The furniture part then runs through spray nozzles 12 over a bath 11, the nozzles being used to spray the furniture part with deionized water.

The same takes place over a bath 13 with spray nozzles 14.

As a result of the three spray treatments of the furniture part, for example, the wall element 1, the wall element 1 has been prepared in order to be sprayed by means of spray nozzles 16 over a bath 15 with a liquid which is to produce the nanoceramic layer 2a.

After this step, drying of the furniture component, for example, the wall element 1, is carried out.

The spray nozzles 10, 12, 14, 16 are in each case supplied from the baths 9, 11, 13 and 15, respectively.

As a result of liquid entrainment during the run-through of a plurality of furniture parts, a liquid level 17a, 17b, 17c and 17d in the individual baths 9, 11, 13 and 15 respectively decreases continuously.

In order to maintain the liquid level in the individual baths, liquid from the bath 11, that is to say deionized water, is fed into the bath 9 via a feed 11a. The same takes place in the bath 11 by means of a feed 13a from the bath 13.

The bath 13 has a feed 17 by means of which, for example, deionized water is fed to the bath 13.

The bath 15 having the liquid for producing the nanoceramic layer 2a is likewise fed with deionized water via a feed 18 in order to maintain a liquid level 17d.

In addition, concentrated liquid for producing the nanoceramic layer 2a is fed to the bath 15 in order to keep the concentration in the bath within a predetermined range when feeding deionized water.

After drying the furniture part after completion of the spraying process over the bath 15 by means of the nozzles 16, the furniture part can be coated with paint, for example, using a powder coating process.

The liquid for producing the nanoceramic layer is preferably chosen such that, after drying, the nanoceramic layer 2a predominantly consists of zirconium oxide.

### LIST OF REFERENCE SIGNS

1 Wall element
2a Nanoceramic layer
2b Layer of paint
3 Installation
4 Arrow
5 Zone
6 Zone
7 Zone
8 Zone
9 Bath
10 Spray nozzles
11 Bath
11a Feed
12 Spray nozzles
13 Bath
13a Feed
14 Spray nozzles
15 Bath
16 Spray nozzles
17 Feed
17a Liquid level
17b Liquid level
17c Liquid level
17d Liquid level
18 Feed

1. A method for producing a furniture part, in particular an element of a drawer, wherein the at least one drawer element is produced from metal or plastic, wherein a nanoceramic layer is applied to a surface of the furniture part before the furniture part is coated with a layer of paint.

2. The method according to claim 1, wherein the furniture part is coated with a layer of zirconium oxide.

3. The method according to claim 1, wherein the furniture part is cleaned before coating with the nanoceramic layer.

4. The method according to claim 1, wherein at least one rinsing step is carried out after the cleaning operation.

5. The method according to claim 1, wherein the nanoceramic layer is sprayed onto the surface of the furniture part.

6. The method according to claim 1, wherein the nanoceramic layer is applied to the surface of the furniture part in a bath.

7. The method according to claim 1, wherein after applying the nanoceramic layer, the furniture part is provided with paint in a powder coating step.

8. A furniture part, in particular drawer element, wherein a nanoceramic layer is applied to a surface of the furniture part.

9. The furniture part according to claim 8, wherein a layer of paint is present on the nanoceramic layer.

10. The furniture part according to claim 8, wherein the layer thickness of the nanoceramic layer is 25 to 75 nm and the layer thickness of the paint is 30 to 100 μm.

11. A piece of furniture having a furniture part according to claim 8.
